(19) United States
(12) Patent Application Publication
(10) Pub. No.: US 2016/0169206 A1
(43) Pub. Date: Jun. 16, 2016

(54) ROTOR OF A WIND TURBINE

(71) Applicant: SSB WIND SYSTEMS GMBH & CO. KG, Salzbergen (DE)

(72) Inventors: Jens SPIELMANN, Steinfurt (DE); Fabio BERTOLOTTI, Bad Bentheim (DE); Norbert KÖTTING, Neuenkirchen (DE)

(21) Appl. No.: 14/904,505

(22) PCT Filed: Jun. 3, 2014
(86) PCT No.: PCT/EP2014/001496

§ 371 Date: Jan. 12, 2016

(30) Foreign Application Priority Data
Jul. 18, 2013 (DE) 10 2013 011 952.9

(51) Int. Cl. F03D 1/06; F03D 7/02; F03D 11/00

(52) U.S. Cl. CPC F03D 11/0091; F03D 1/0675; F03D 1/0691; F03D 7/0264

(57) ABSTRACT

The invention relates to a rotor of a wind turbine, comprising a rotor hub (8), which has at least one rotor blade (9, 10) protruding perpendicularly to the rotor axis (7), which at least one rotor blade can be adjusted in an angular range about the blade axis (11, 12) of the rotor blade with respect to the the blade bearing point (32) of the blade in the hub (8), and at least one sensor (18), which is connected to at least one evaluating unit (19) arranged in the hub (8) by means of a rotatable cable connection (20) suitable for energy transmission and/or communication. The cable connection (20) has at least one or more guiding elements (23). The guiding element (23) has one fastening point (24, 25) each in the rotor hub and in the rotor blade and comprises at least one element (26, 29) that is elastic in tension. The invention is characterized in that the guiding element (23) can be stressed and relaxed and can be detached at at least one fastening point (24, 25), and means (38) are provided for registering a malfunction of the cable connection (20) in the event of a fault.

### FIELD

The invention relates to a rotor of a wind turbine.

### BACKGROUND

In order to monitor and control a rotor of a wind turbine, there may be arranged sensors in one or each of the protruding rotor blades and in the rotating hub evaluation units for the sensors, which are connected to each other by means of cables or lines and which bridge one or more bearing locations of a rotor blade on the hub. The cables or lines may be constructed depending on the construction of the sensors as electrical, optical cables or lines or as hydraulic or pneumatic hoses, which are referred to below as cables.

Using such a cable connection, aerodynamic blade loads, blade properties or other states in the rotor blade may be registered or measured and transmitted to the evaluation unit in the rotating hub. From the measurement values, control signals are then generated for the rotor of the wind turbine.

Since the rotor blades can further be adjusted about the blade axis thereof, referred to below as pitch controlled or simply “pitching”, the cable is additionally loaded in the blade/hub transition region since the blade can additionally be adjusted with respect to the rotating hub in an angular range, that is to say, rotated perpendicularly relative to the hub axis. The necessary cable length between the device in the rotor blade and in the hub changes by means of torsion with the pitch movement so that neither of the two cable fixing locations—both at the rotor blade side and at the hub side—is located on the blade axis or towards the extension thereof in the hub. This makes guiding of the cable in the transition region necessary. Damage or malfunction of the cable connection would lead to failure or malfunction of the sensors which are arranged in the blade, which would involve significant safety problems for the entire wind turbine.

In practice, it is known to secure the cable in the transition region to a retention member which is arranged in the hub opening and which prevents the cable from becoming compressed and damaged by the rotational movement during pitching. However, as a result of the blade rotation, this requires that the retention member be arranged centred with respect to the rotor blade, whereby, for example, during maintenance or repair operations in the rotor, access to the blade is very significantly impeded. During such operations close to the blade bearing in the hub or when the blade is accessed, the retention member has to be disassembled and subsequently re-assembled and accordingly centred since otherwise the cable may become damaged.

During normal operation, the rotor blade is pitched only through 90°, wherein it is also possible for the blade to also have to be pitched further than 90°. With such pitch movements, or even larger pitch movements, even as far as a complete rotation of the rotor blade through 360°, there is further also the risk of cable breakage.

The securing of the cable connection both in the hub and in the rotor blade has to be guided centrally relative to the rotor blade axis and the hub opening since otherwise the cable would be guided eccentrically during pitching, and is subjected to extreme loading. In a loop guiding of the cable in the narrow transition region of the hub opening, there is further the risk that the cable will become damaged during the pitching operation. However, the reproduction of the central securing of the cable connection in the transition region involves considerable complexity for the service operators as a result of the limited working space.

The problem of the cable transition in the blade bearing region could be solved with a slip ring arrangement (see in this regard, for example, DE 201 16 756 U), as is generally used for the transition between the fixed and movable components of wind turbines (for example, the rotor/pod or pod/tower transition). However, the slip ring solution is very expensive and has considerable technical disadvantages with respect to its functionality and transmission reliability. It is not suitable for the hub/blade transition.

As an additional possibility, running chains or energy chains can be used as a cable connection which, however, have the disadvantage that they take up an excessive amount of space and do not enable assembly or disassembly.

From the prior art, there are further known transitions of electrical energy and communication cables between the rotating pod and the fixed tower in wind turbines, as disclosed in WO 2010 135 844 A. The document sets out a wind turbine having a tower and a pod which can be rotated with respect to the tower. Between the pod and tower, a transition in the form of a cable having a suspension device is arranged. The transition comprises a tightly tensioned carrier element in the form of a cable or a chain, which is secured with one end to the pod and with the other end to the base of the tower. The cable hangs downwards in a snake-like manner and is connected to the carrier element in each case between two adjacent bends of the cable. Similar solutions for the pod/tower transition are known from WO 2010 105 852 A, EP 2587 054 A and EP 1 921 311 A.

The known solutions for the transition between the pod and tower cannot, however, be transferred to the transition within the rotor, that is to say, between the rotating hub and the rotor blade, which can be adjusted perpendicularly relative thereto since, as a result of the rotation of the hub, the transition of the cable is partially guided overhead so that rigid retention would be required for the cable, as is also carried out in practice. As a result of the available structural space which is limited in comparison with the pod/tower transition in the hub/rotor blade transition, the solutions proposed in the documents are not transferrable.

WO 2013 091380 A sets out a rotor of a wind turbine having a blade which can be adjusted about the axis thereof and in which there is installed a lightning conductor which is connected by means of an electrical cable connection to a lightning test device in the rotating hub. In the bearing region of the adjustable blade and the rotating hub, a tightly tensioned tension cable is arranged as a position limiter, wherein the two ends of the tension cable are secured to a fixed location in the blade or in the hub and are connected to the cable connection so that the cable connection is always tensioned between the fixed location in the hub and the bearing region of the blade.

The known cable connection is fixedly installed. Maintenance or repair operations in the device are not possible or possible only with considerable complexity. There is no provision for detection of a malfunction of the cable connection.

An object of the invention is to provide in a rotor of a wind turbine a reliable and robust transition between a pitching rotor blade and the hub of the rotor of a wind turbine, which produces a reliable and rotatable connection, wherein it should also be taken into account that, in the event of maintenance, assembly or disassembly operations in the rotor, the cable connection is simple to assemble or disassemble. The cable connection should also be as light and robust as possible since, as a result of the operation in the limited space, occurrences of damage may otherwise readily occur at the transition.

### SUMMARY

The inventive solution involves the features of the independent claim. The dependent claims relate to advantageous developments.

The invention relates to a rotor of a wind turbine, comprising a rotor hub having at least one rotor blade which protrudes perpendicularly relative to the rotor axis and which can be adjusted about the blade axis thereof with respect to the blade bearing location thereof in the hub in an angular range, and which has at least one sensor which is connected by means of a rotatable cable connection which is suitable for energy transmission and/or communication and which has at least one evaluation unit which is arranged in the hub, wherein the cable connection has at least one or more guiding elements, the guiding element in each case has a securing location in the rotor hub and in the rotor blade, comprises at least one tenso-resilient element, can be tensioned and relaxed, can be released at least at one securing location, and means are provided in order to register a malfunction of the cable connection in the event of a failure.

As a result of a tenso-resilient element which is arranged in the guiding element, there is produced a cable connection which is advantageously tensioned at all times by specific tension elements and can optionally be re-tensioned. The connection consequently cannot swing back and forth during rotation of the rotor. In particular also with each pitch movement of the rotor blade, it remains tight and tensioned. The cable connection is not additionally loaded by the pitching of the rotor blade. The guiding element is adapted to each pitch angle. Consequently, a technical measurement connection is produced between the pitch angle and the mechanical tension of the guiding element which can optionally be used as an additional control variable for the wind turbine.

The guiding element is secured with one end thereof at the side of the rotor hub, as the component which does not rotate with respect to the rotor blade, and with the other end in the rotor blade. The cable which is guided by the guiding element—that is to say, the cable connection—can either be fixedly wired or simply assembled and disassembled by means of a plug type, screw type or hook type connection. During maintenance and assembly operations in the hub/rotor blade transition region, the service operators are no longer impeded by drooping cables. The tenso-resilient element can be produced in different embodiments.

The means advantageously comprise measurement or monitoring devices and are part of a safety device of the wind turbine which, when the cable connection or non-tensioned guiding element is damaged, stops the wind turbine or no longer allows it to start if it was previously stopped. Consequently, not only the cable connections between the rotating hub and the blade bearing, but also the sensors in the blade are integrated in the so-called “safety chain” of the installation.

Advantageously, the measurement or monitoring devices are arranged in the tenso-resilient element and have measurement arrangements by means of which not only the functionality of the cable connection but also the mechanical tension or the redirection of the tenso-resilient element can be measured and monitored. In the event of malfunction, in the event of damage or a non-tensioned guiding element, an error message is generated or the safety chain is interrupted.

The ability of the guiding element to be tensioned may be configured so as to be adjustable and carried out whilst the tenso-resilient connection is connected, or also when this connection is interrupted, or even when it is hooked out and interrupted. The length of the cable in the connection may be adapted in accordance with the tension of the guiding element by means of loop formation, helix formation or similar measures. The inventive guiding element is significantly more cost-effective in comparison with the slip ring or carrier element solutions described in the introduction. In the event of a defect, rapid and cheap exchange is possible. Very little structural space is required since no additional retention member is required.

The guiding element can be released at least at one securing location. For maintenance operations in the rotor blade or in the hub in the region of the hub opening, the connection can be removed in a simple and rapid manner by releasing the plug type, screw type or wire connection. For disassembly, it is sufficient at one side—either at the hub or rotor blade side—to unclamp, unscrew or unplug the incoming line from the consumer and to release the plug type, screw type and hook type fixing of the guiding element. Afterwards, the released connection can be simply pushed to one side or even be completely disassembled with a few manual operations—and almost without any tools. Consequently, an unencumbered operation between the hub and rotor blade is possible or the access to the rotor blade is possible without disruptive additional components. Subsequently, the line connection can be produced again with a few manual operations and without additional tools. Eccentric securing locations, whereby a variable arrangement of the guiding element is achieved, can be corrected by means of the tenso-resilient element.

In another advantageous embodiment of the invention, it is proposed that the securing location of the tenso-resilient guiding element in the rotor blade of the tenso-resilient guiding element be arranged in the region of the blade root thereof, wherein the region which is referred to as the blade root is the region of the rotor blade which is secured to the blade bearing in the hub opening.

In order to prevent portions or particles which are present in the blade from being able to fall into the hub as a result of the rotation, the rotor blades very often have in the region of the blade root a covering plate which closes the opening of the blade and which is also referred to as a “bulkhead” but in which a so-called “manhole” is provided in order to thus enable access to the blade. In the region of this “bulkhead”, the guiding element can then advantageously be releasably secured.

The region of the hub opening on the blade bearing is then advantageous as a corresponding securing location in the hub, wherein advantageously only this securing location is intended to be arranged centrally in the hub opening in the region of the blade bearing.

In a first embodiment, the tensile resilience of the cable connection can be produced by means of a pipe which can be displaced inside itself in the manner of a telescope and which can be varied in terms of its length by means of the pitch movement of the rotor blade. The cable is then guided inside the telescope-like pipe, wherein the cable is guided in a helical manner for the length compensation during pitching in the telescope-like pipe. However, in order not to impede access to the blade through the telescope-like connection which is rigid in a radial direction, it is advantageous to arrange the connection not centrally in the blade centre or in the blade bearing, but instead at the edge of the blade or blade bearing.

This embodiment of the tenso-resilient guiding element has the advantage that the variable length of the telescopic retraction as a result of pitching can be monitored or measured by a corresponding additional measurement or sensor arrangement. Using this sensor device, it is not only possible to make a statement relating to the functionality of the cable connection, but also to obtain a statement relating to the pitch angle adjusted. The sensor signal can then be processed by the wind turbine control as an additional control signal.

Alternatively and preferably with respect to a telescope-like arrangement, the guiding element may be constructed as a wire or cable to which the cable is secured, or to a cable sleeve which is placed around the cable to be guided and which may be secured to at least one of the two securing locations. In this embodiment, the tenso-resilient properties of the guiding element may be produced by means of a tension spring or a tension element which is arranged at one or both securing locations of the guiding element. Consequently, the cable connection is tensioned at all times. The tensioning and re-tensioning ability of the connection can be produced in that alternatively or as an additional element a tension element or turnbuckle is arranged in the connection, wherein the turnbuckle can also be secured by means of a simple-to-assemble and disassemble plug type, screw type or hook type connection to the corresponding securing location on the rotor blade or the rotor hub or at both sides. A tension lever closure which is arranged in the guiding wire or cable with a tenso-resilient element can, for example, be tensioned and relaxed in a rapid and simple manner by means of a hand movement using no additional tools. This is advantageous during assembly and maintenance operations in the narrow motor space of the wind turbine.

It is not necessary for the guiding element in this embodiment to be secured at both securing locations in the rotor hub and in the rotor blade centrally in the region of the blade axis (in the blade) or the extension thereof in the hub. It is sufficient for it to be secured only at one of the two sides, the rotor blade or the rotor hub so that the cable connection is always tensioned and does not relax when the rotor blade is pitched. As a result of the tenso-resilient connection, it is further possible to deviate slightly from this one or two-sided central securing position since the resilience thereof permits a degree of length variation of the tensile connection. Depending on the location of the entrance into the space between the hub and rotor blade, the cable connection can be fitted or released without making it difficult for a person to access this region. This is particularly advantageous for the securing of the tenso-resilient guiding element after the reassembly of the cable connection after maintenance and repair operations.

In the embodiment of the cable connection as a pull cable or wire, there are also integrated sensor or monitoring devices by means of which it can be monitored whether the arrangement is tensioned or functional, whereby, in the event of a malfunction in the event of damage or a non-tensioned guiding element, an error message can be generated or the safety chain is interrupted, whereby the wind turbine is stopped or does not start up if it was previously stopped.

Other advantageous embodiments of the invention may be taken from the description and the embodiments described below.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic illustration of a wind turbine,

FIGS. 2a and 2b show a first embodiment of the invention with a cable or wire as a guiding element for a cable connection between a rotor hub and a rotor blade of the wind turbine,

FIGS. 3a and 3b show a tension lever closure and a tension element for tensioning and relaxing the cable connection according to FIGS. 2a and 2b,

FIGS. 4a and 4b show a second embodiment of the cable connection having a cable sleeve as a guiding element,

FIG. 5 shows a variant of the embodiment according to FIG. 2 with a cable connection from the centre of the hub to the edge in the rotor blade,

FIG. 6 shows the embodiment according to FIG. 5, but with a disassembled cable connection,

FIG. 7 shows another embodiment of the cable connection,

FIG. 8 shows the embodiment according to FIG. 7, but with a disassembled cable connection, and

FIGS. 9a to 9c show another embodiment of the cable connection with a telescopic pipe as a guiding element and as a tenso-resilient element.

Corresponding reference numerals indicate corresponding parts throughout the several views of the drawings.

### DETAIL DESCRIPTION OF DRAWINGS

Example embodiments will now be described more fully with reference to the accompanying drawings.

In FIG. 1, a wind turbine 1 can be seen, wherein a tower 3 which is standing on a foundation 2 is connected at the end thereof facing away from the foundation 2 to a machine housing which is also generally referred to as a pod 4. In the pod 4 there is arranged a machine carrier 5 on which a rotor 6 is rotatably supported about a rotor axis 7 which has a rotor hub 8 and two visible rotor blades 9 and 10 connected thereto which are connected to the hub 8 by means of a blade bearing 32, respectively, and which can each be rotated about the blade axes 11, 12 thereof relative to the rotor hub 8. Each rotor blade 9, 10 is mechanically coupled to an adjustment drive (pitch drive) 13, 14 by means of which the respective rotor blade 9, 10 is rotated about the associated blade axis 11, 12 (referred to below as pitching) and is mechanically coupled to an electrical generator 16 which is arranged in the pod 4 and which is secured to the machine carrier 5 and which converts the wind energy 15 which is acting on the individual rotor blades for the most part into electrical energy. For the controlled operation of the wind turbine 1, there is provided a superordinate wind turbine control system 17 by means of which inter alia the adjustment drives 13 and 14 are controlled.

In the rotor 6, devices 18 and 19 are arranged both in the hub 8 thereof and in the two illustrated rotor blades 9 and 10, wherein the device which is arranged in a rotor blade 9 or 10, respectively, is given the reference numeral 18. The device which is arranged in the hub 8 and which is associated with the rotor blades 9 and 10, respectively, is given the reference numeral 19.

The device 19 in the hub 8 may, for example, be an electric or hydraulic motor for the adjustment drive 13 or 14, a switching cabinet or an electrical, pneumatic or hydraulic control cabinet for the adjustment drives or similar devices. The two devices 18 and 19 may be connected either directly to each other or indirectly by means of a non-illustrated connection to the wind turbine control system 17 which then generates control signals for the corresponding adjustment drive 13, 14, by means of which the respective rotor blade rotates about the axis 11, 12 thereof.

It is also possible for the two devices 18 in the blades to be connected to only one device 19. That is to say, only one device 19 is provided in the hub 8 in place of two. It is also not absolutely necessary for these devices to be connected to the wind turbine 1 control system, which then generates control signals for the pitch drives.

The devices 18 which are arranged in the two rotor blades 9 and 10 are sensor devices, which register and/or measure the aerodynamic states of the respective rotor blade. The sensor signals are transmitted via a cable connection 20 to the respective device 19 in the hub 8, wherein with this cable connection 20 it has to be taken into account that the connection is partially guided overhead by the rotation of the rotor 6 and additionally the rotation of the rotor blade (pitching) has to be taken into account so that the cable connection during the pitch movement is not damaged by a rotor blade bearing 32 which is arranged on the hub 8. The device 19 is consequently an evaluation unit of the sensors 18 which are arranged in the blade.

In the following described embodiments of the invention, components with the same functions are always given the same reference numerals. In a state hidden by the two rotor blades 9 and 10, the wind turbine 1 further has a third rotor blade with all the above-described components.

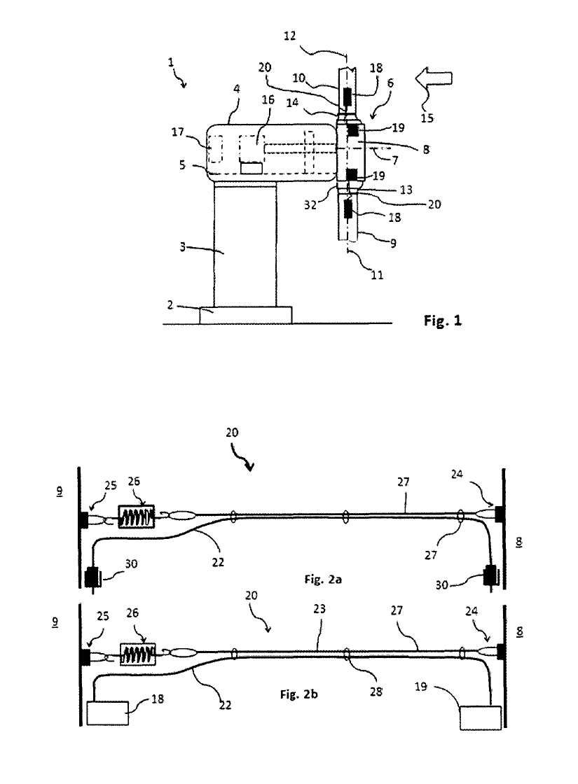

A plurality of embodiments of the cable connection 20 are described in greater detail below with reference to a plurality of illustrations. In all the illustrations, the connection 20 comprises a rotatable cable 22 which is suitable for energy transmission and/or communication and which has a guiding element 23, wherein the guiding element 23 has a securing location 24 in the rotor hub 8 and a securing location 25 in the rotor blade 9. The guiding element 23 further has a tenso-resilient element 26 which is illustrated in FIGS. 2 to 8 as a tension spring in the drawings. However, as will be explained below in the subsequent description of the Figures, the element 26 can also be produced in other embodiments.

In FIGS. 2a and 2b, the guiding element 23 is illustrated as a cable or wire (reference numeral 27) with a tenso-resilient element 26 in each case, on which the cable 22 is secured and guided by means of line fastenings 28. The tenso-resilient element 26 comprises in FIG. 3a a tension lever closure with a spring or a resilient strip, wherein the tension lever closure has a lever 21 for tensioning and relaxing the cable connection 20, as shown in FIG. 3a. In FIG. 3b, the tenso-resilient element 26 comprises a tension element 29 having a spring or a rubber band. The tension lever and tension element 29 are not resilient per se. With a hand movement, and without tools, the cable connection 20 can consequently be tensioned or released.

As can further be seen from FIGS. 2a and 2b, the cable 27 is releasably secured to the securing location 25 in the rotor blade 9 by means of a hook connection. In contrast, the securing location 24 on the hub 8 is illustrated so as to be fixed and non-releasable, although at this securing location a releasable hook connection can also be arranged. By releasing or tensioning the tension lever closure/tension element 29, the cable connection 20 can be either assembled or disassembled. In FIG. 2a, the cable 22 has a releasable plug type connection 30 by means of which it can be connected either to the device 18 in the blade 9 or to the device 19 in the hub 9. In FIG. 2b, the cable 22 is securely connected to the device (i.e., sensor) 18 and the device (i.e., evaluation unit) 19.

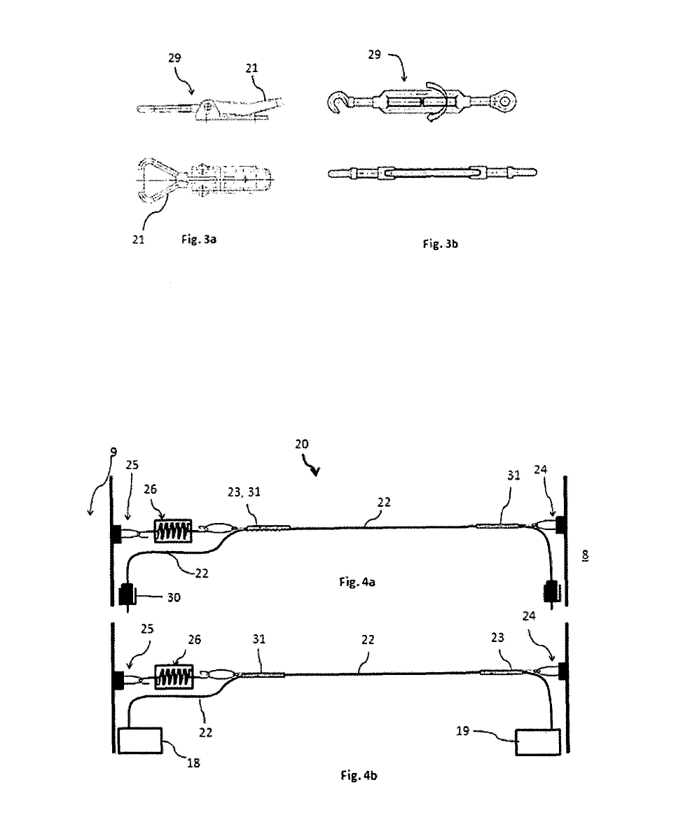

In FIGS. 4a and 4b, the guiding element 23 is constructed as a cable sleeve 31, in which the cable 22 is guided in the region of the securing locations 25, 24 thereof. So that the connection remains tensioned during pitching, the tenso-resilient element 26 is arranged in the region of the securing location 25 in the rotor blade 9. The cable sleeve configuration has the advantage that it has an even lower weight compared with the wire or cable embodiment 27.

For reasons of simplicity, in FIG. 5 to FIG. 7, the guiding element 23 is illustrated as a cable or wire 27 with a dual-sided plug type connection 30. However, these illustrations also apply to the embodiment with the cable sleeve 31 or when the cable 22 is fixedly wired to the respective device 18, 19.

The illustration in FIG. 5 has the same cable connection 20 as already described in FIG. 2a. The securing location 25 in the blade 9 is, however, in contrast to the illustrations in FIGS. 2a and 2b, arranged at the lower blade edge.

The rotor blade 9 is connected to the hub 8 via the rotor blade bearing 32, by means of which the pitch movement is carried out by means of the adjustment drive 13. In the blade bearing region, there is also arranged the device (i.e., evaluation unit) 19 which represents in this instance a control or switching cabinet from which the cable connection 20 leads to the device (i.e., sensor) 18 in the rotor blade 9, by means of which physical properties of the rotor blade can be registered and are then transmitted as a signal via the cable 22 to the device (i.e., evaluation unit) 19 in the hub 8.

The securing location 25 is further arranged in a region of the rotor blade 9 which adjoins the blade bearing 32 as closely as possible and which is generally referred to as a blade root 33. In order to prevent components which are flying around in the rotor blade from being able to fall into the hub 8 opening during rotation or to prevent a person from being able to fall into the hollow rotor blade during operations in the hub 8, the rotor blade 9 has in the region of the blade root 33 thereof a covering plate 34 which is also referred to as a “bulkhead”. However, the covering plate 34 has at the height of the blade axis 11 an opening 35, a so-called “manhole”, in order where applicable to enable access to remote regions of the rotor blade 9. In FIG. 5, it can be seen that the securing location 25 is arranged on the covering plate 34. The device (i.e., sensor) 18 is further also arranged at that location.

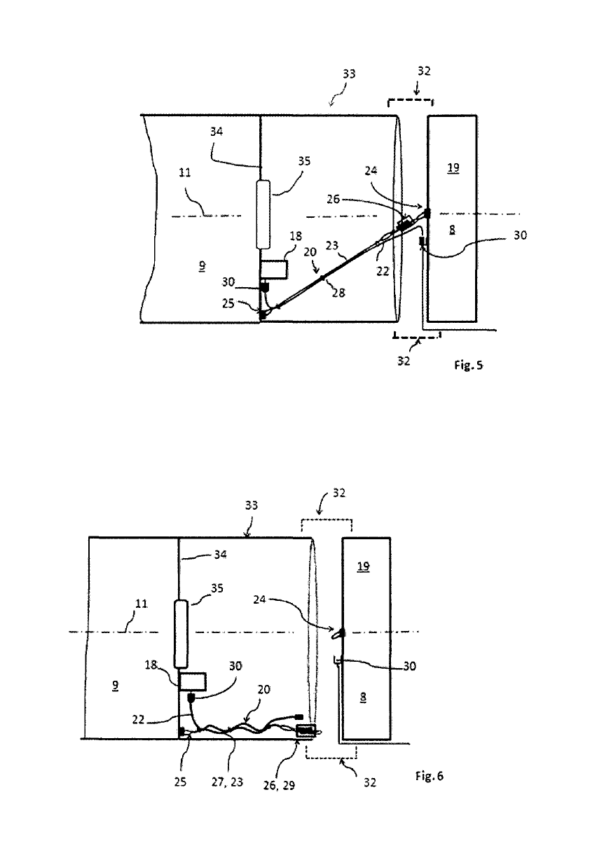

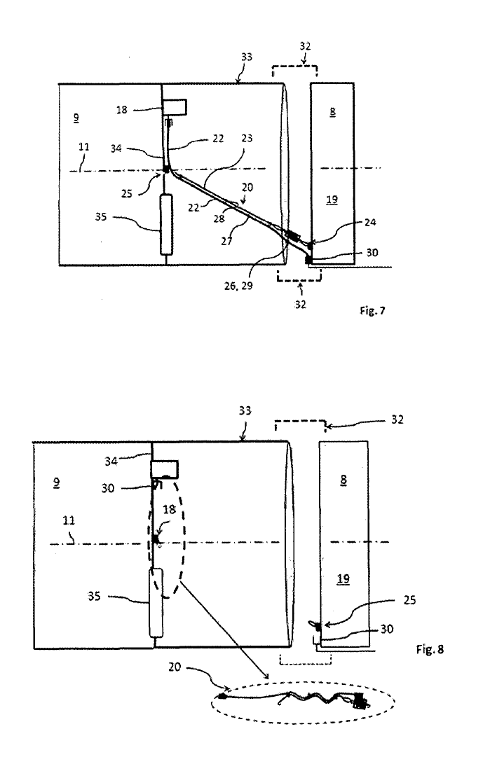

FIG. 6 shows the same embodiment as FIG. 5, but with a disassembled cable connection 20. The guiding element 23 which is constructed as a cable or wire 27 was disassembled by releasing the tension lever closure or the tension element 29 at one side from the securing location 24 thereof and the plug type connection 30 in the rotor 6. The cable connection 20 can consequently be pushed to the blade edge, on which the securing location 25 in the blade root 33 is also arranged so that access to the blade root 33 and to the “manhole” 35 is consequently no longer impeded by the cable connection 20.

FIG. 7 shows an assembled cable connection 20 which is guided from the lower edge of the hub 8, on which the securing location 24 is also arranged for the guiding element 23 (cable, wire), to the sensor 18 in the blade 9 which is arranged on the upper blade edge, wherein the securing location 25 in the blade in this embodiment is arranged centrally on the blade axis 11.

FIG. 8 shows the cable connection 20 of the embodiment according to FIG. 7, but disassembled at both sides. The dual-sided disassembly also applies to the embodiments according to FIG. 5 to FIG. 7.

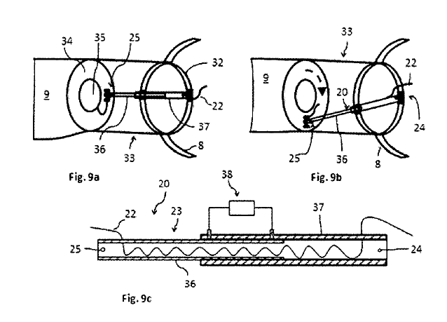

FIGS. 9a to 9c illustrate an alternative embodiment of the cable connection 20, in which the cable 22 is guided in a helical manner in a telescope-like arrangement having an inner pipe 36 and an outer pipe 37 which can be adjusted coaxially in an axial direction. As in the previous embodiments, the securing location 24 is arranged in the region of the blade bearing 32 in the hub 8, the securing location 25 on the “bulkhead” 34 is arranged in the region of the blade root 33. So that the access to the “manhole” 35 is not impeded by the cable connection 20, the securing locations 24 and 25 are each arranged in an articulated manner at the edge of the blade root 33 and the blade bearing 32 in order to follow the pitch movement. FIG. 9a shows the position of the rotor blade with an assumed pitch angle of 0°. FIG. 9b illustrates the position with an adjustment of the rotor blade through 90° with respect to the position of FIG. 9a.

FIG. 9c is a sectioned illustration of the cable connection 20 with a schematically illustrated measurement arrangement 38 for measuring the displacement between the outer pipe and inner pipe. By means of the measurement value which is registered in this manner, on the one hand, the functionality of the connection can be established, on the other hand, however, it is also a measurement for the adjusted pitch angle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-13. (canceled)

14. A rotor for a wind turbine, comprising:
a rotor hub having at least one rotor blade which protrudes perpendicularly relative to the rotor axis and which can be adjusted about the blade axis thereof with respect to a blade bearing location thereof in the hub in an angular range;
the rotor hub having at least one sensor which is connected by means of a rotatable cable connection which is suitable for energy transmission and/or communication;
the rotor hub further having at least one evaluation unit which is arranged in the hub, wherein the cable connection has at least one or more guiding elements, and wherein the guiding element in each case has a securing location in the rotor hub and in the rotor blade and comprises at least one tenso-resilient element; and
wherein the guiding element can be tensioned and relaxed, and can be released at least at one securing location, and means are provided in order to register a malfunction of the cable connection in the event of a malfunction.

15. The rotor according to claim 14, characterised in that the means comprise measurement or monitoring devices and are part of a safety device of the wind turbine which, when the cable connection or non-tensioned guiding element is damaged, stops the wind turbine or no longer allows it to start if it was previously stopped.

16. The rotor according to claim 14, characterised in that the means are arranged in the tenso-resilient element and have measurement arrangements by means of which the functionality of the cable connection, a mechanical tension or a redirection of the tenso-resilient element can be measured and monitored.

17. The rotor according to claim 16, characterised in that, by means of the measurement arrangement, the adjustment of the rotor blade with respect to the blade bearing location thereof can be registered and measured.

18. The rotor according to claim 14, characterised in that the securing location in the rotor blade is arranged in the region of the blade root thereof and the securing location in the rotor hub is arranged in the region of the rotor blade bearing of the hub.

19. The rotor according to claim 14, characterised in that the tenso-resilient element comprises in combination with the guiding element at least two or more coaxially arranged and telescopically displaceable pipes, inside which a rotatable cable (22), which is suitable for energy transmission and/or communication, is guided in a helical manner.

20. The rotor according to claim 14, characterised in that the two securing locations are constructed in an articulated manner.

21. The rotor according to claim 19, characterised in that at least one of the telescopic pipes is guided in a radially offset manner with respect to the blade axis.

22. The rotor according to one or more of claim 14, characterised in that the guiding element is constructed as a cable or wire, a cable sleeve or the like, and
a rotatable cable, which is suitable for energy transmission and/or communication, is connected to the guiding element between the two securing locations.

23. The rotor according to claim 22, characterised in that the tenso-resilient element is a tension spring or a resilient strip having an actuatable tension element and is arranged in the region of a securing location.

24. The rotor according to claim 22, characterised in that the cable has a loop in the region of the tenso-resilient element.

25. The rotor according to claim 14, characterised in that the cable connection comprises electrical, optical, hydraulic or pneumatic cables, lines or a loop.

26. The rotor according to claim 14, further comprising the wind turbine.

27. A rotor for a wind turbine, comprising:
a rotor hub having at least one rotor blade;
the rotor hub having at least one sensor which is connected by means of a rotatable cable connection which is suitable for energy transmission and/or communication;
the rotor hub further having at least one evaluation unit which is arranged in the hub, wherein the cable connection has at least one or more guiding elements, and wherein the guiding element in each case has a securing location in the rotor hub and in the rotor blade and comprises at least one tenso-resilient element; and
wherein the guiding element can be tensioned and relaxed, and can be released at least at one securing location.

28. The rotor of claim 27, having at least one rotor blade which protrudes perpendicularly relative to the rotor axis and which can be adjusted about the blade axis thereof with respect to a blade bearing location thereof in the hub in an angular range.

29. The rotor of claim 27, further comprising means operable to register a malfunction of the cable connection in the event of a malfunction.

30. The rotor of claim 27, characterised in that the tenso-resilient element comprises, in combination with the guiding element, at least two or more coaxially arranged and telescopically displaceable pipes, inside which a rotatable cable, which is suitable for energy transmission and/or communication, is guided in a helical manner.

31. A rotor for a wind turbine, comprising:
a rotor hub having at least one rotor blade the rotor hub having at least one sensor which is connected by means of a rotatable cable connection which is suitable for energy transmission and/or communication;
the rotor hub further having at least one evaluation unit which is arranged in the hub, wherein the cable connection has at least one or more guiding elements, and wherein the guiding element in each case has a securing location in the rotor hub and in the rotor blade and comprises at least one tenso-resilient element;
wherein the guiding element can be tensioned and relaxed, and can be released at least at one securing location; and
wherein the tenso-resilient element comprises in combination with the guiding element at least two or more coaxially arranged and telescopically displaceable pipes, inside which a rotatable cable, which is suitable for energy transmission and/or communication is guided in a helical manner.
